(19) United States
(12) Patent Application Publication
(10) Pub. No.: US 2018/0305078 A1
(43) Pub. Date: Oct. 25, 2018

(54) Pressurized Beverage Dispensing System

(71) Applicant: Jon Wright, Carlsbad, CA (US)

(72) Inventor: Jon Wright, Carlsbad, CA (US)

(21) Appl. No.: 15/960,362

(22) Filed: Apr. 23, 2018

Related U.S. Application Data
(60) Provisional application No. 62/488,559, filed on Apr. 21, 2017.

(51) Int. Cl. B65D 21/02; B67D 1/08

(52) U.S. Cl. CPC B65D 21/0215; B65D 21/0237; B67D 2210/00031; B67D 1/0892; B67D 2001/0825; B67D 1/0802

(57) ABSTRACT

A keg positioning system is provided having a flexible portion of an internal spear for beverages dispensed from the internal cavity of a beverage keg. The flexible portion enables use of the keg in both a vertical or horizontal orientations, with minimal waste of the beverage. A frame may also be employed to provide for vertical stacking of multiple kegs above a support floor space sized for the lowest frame in the stack.

This application claims priority to U.S. Provisional Patent Application Ser. No. 62/488559, filed on Apr. 21, 2017, which is incorporated herein in its entirety by this reference thereto.

### FIELD OF THE INVENTION

The present invention relates to the dispensing of beverages from containers under pressure. More particularly, it relates to a metal container configuration for containers of beverages which are fermented and then shipped in the metal container. The system allows for dispensing the liquid beverage, in both a horizontal and vertical storage position, with a complete emptying of the beverage from the container in either position. In other modes, stacking of the container is provided to save cold storage space and allow for beverage selling establishments to increase the number of different beverages which may be dispensed from containers using the same or a smaller cold storage area.

### PRIOR ART

For beer and ale served in bars and restaurants, breweries conventionally sell their brewed beverages in metal containers more commonly known as kegs. Modern beer and ale kegs are made of stainless steel, or in some cases aluminum. An interior cavity of the keg is filled with a brewed beverage for shipping to commercial customers, and modernly, this keg is employed for cold storage of the beer it contains, as well as dispensing of the beer.

Conventionally, a beverage keg has two endwalls and a sidewall extending therebetween which define an interior cavity between the endwalls and sidewall. A modern keg has a single opening on one endwall conventionally called a “bung.” A tube known as a “spear” extends from a first end positioned at the opening, to a distal end. This spear has a length adapted to position the distal end at a slight distance from the opposing endwall of the keg. Conventional beverage keg spears are rigid metal such as those sold by the MicroMatic Company of Northridge, Calif.

Conventional beverage kegs include a self-closing coupling valve which is opened by a removably engageable coupling fitting which is attached when the keg is tapped. On modern kegs there is also included an opening communicating with the first end of the spear which allows gas (usually carbon dioxide) to be communicated into the cavity of the keg, which is employed to force the beer from the internal cavity, through the coupling valve, and into an engaged coupling fitting which may have a hose or spigot connected. The coupling fitting may also have one or two valves which are adjustable to control the outflow of beer and the inflow of the gas into the keg.

Conventionally, to use the keg to dispense beer, ale, or another fully mixed beverage, the keg must be positioned with the first endwall of the keg having the coupling valve upright, and the keg seated on the second endwall opposite the first endwall having the coupling valve. In this upright position, the elongated tube defining the spear, will intake beer or other beverages from the distal end. With the coupling valve upright, it is conventionally considered to be easier to engage either a spigot or tubing to communicate the exiting brew to a spigot.

Further, in order to prevent the waste of portions of the beverage in the interior cavity of the keg as it gets low, the distal end of the rigid tube defining the spear will be of a length to position it a few millimeters from the second endwall opposite the first endwall from which the spear extends. Additionally, on many modern beverage kegs, the second endwall opposite from that holding the coupling valve is shaped to form a recess at the center of the opposing second endwall, which is lower than the intersection of this endwall with the sidewall. This causes the beer, ale, or other beverage in the interior of the keg, to form a puddle in the relief formed in a central area of that opposing endwall, and allows for the collection and forcing of virtually all the liquid from the keg to avoid waste.

The forgoing examples of related art for conventional beverage kegs and rigid metal spears, and limitations related therewith, are intended to be illustrative and not exclusive, and they do not imply any limitations on the invention and method described and claimed herein. Various limitations of the related art are already or will become apparent to those skilled in the art upon a reading and understanding of the specification below and the accompanying drawings.

### SUMMARY OF THE INVENTION

The system and device herein, allows for the positioning of such kegs, in a horizontal disposition, rather than the conventional vertical disposition. It has been found in experimentation that positioning of beverage kegs in a horizontal disposition allows for stacking and, thus, an elevated positioning of multiple kegs in the same floor space as a single beverage keg. This has been found to maximize and organize, as well as increase the number of beverage kegs which may be stored in the same cold storage area as a single ground positioned upright keg. Such allows restaurants and bars to offer more brands of beverages or to reduce the floor space in a cooler used for beverage kegs, either of which provides significant utility to owners of such establishments.

Initially a simple pyramid type stacking allowed for a plurality of kegs to be vertically positioned over a small underlying floor space in the cooler normally occupied by single upright kegs. Such a stacking worked well as it left the endwall having the coupling valve exposed for engagement to tubes for carrying the beverage. However, during further experimentation, to increase storage in a commercial cooler and allow for more spigots at the bar from more kegs in the cooler, it was found unexpectedly that the kegs tended to angle horizontally in an unpredictable fashion over time in such a pyramid of containers stacked upon and against each other. It was found this was due to keg dimensions and different shapes provided by different brewers. Further, while doable, it was found to be time consuming to replace a single empty keg at the bottom of the stack.

The system herein, was then developed which employs a stackable frame or beverage keg holder having a frame passage sized to engage around the exterior of any conventional beverage keg supplied to restaurants, bars, and even homes. Using the developed keg holder stacking frame, the keg may be positioned in a horizontal disposition supported by the keg sidewall on the lower side surface of the frame passage. Using the frames which are stacked and engaged with each other from two for example, to a stack six high or more, removal and replacement of lower positioned beverage kegs from respective frame passages becomes an easy chore.

However, unexpectedly, it was found the horizontal positioning of the keg in the frames increased wasted beverage, as commercial projecting tubes or spears are configured for ingress of the beverage adjacent to an opposing endwall through a closely placed distal end of the projecting tube forming the spear. One solution to the developed problem was to employ a curved rigid metal tube for the spear with a distal end close to the sidewall. This configuration works. However, it requires the keg be marked for a bottom-down position and that the user register the keg in position on the rack to place the curved top and the lowest point of the sidewall. Because the extension of the spear from the coupling valve is dependent on a number of variables, such as varying tightening by different users, during experimentation it was found that the curved spear tube did not always end up in the correct position even when a direction was marked.

A forming of a portion of the tubing forming the spear from a flexible tubing of a material, such as silicone, was found to solve the problem initially. However, unexpectedly, it was found in a liquid environment, the distal end of the spear formed by the flexible tube did not always settle to the lowest point of the sidewall of the keg. The addition of a flared weighted end piece to the flexible portion of the tubing forming the spear was found to provide the best mode of the device and system herein. The weighted distal end employs gravity to self-position the distal end of the tube forming the spear, substantially centered and adjacent or in contact with the lowest point of the sidewall of the horizontally placed keg. The flaring of the end of the end piece solved another problem that initially developed with a non-flared weighted end piece, in that the opening for ingress of fluid flowed better when the opening end of the flared endpiece was used. As such, in the most preferred mode of the device herein, an endpiece formed of metal, such as stainless steel, is engaged to the distal end of the flexible tube portion of the spear. Further preferred is a frustoconical shape where a wider opening provides the intake for fluid which is communicated to the flexible tube engaged opening.

As such, the system herein may be employed with just the stackable frame having a declining angle for the support surface toward the endwall of the keg opposite that hosting the coupling valve in a minimized fashion. Enhanced function is provided by inclusion of a flexible portion of the tubing forming the spear extending from the coupling valve. Optimum performance is achieved where a weighted metal end piece is engaged with the distal end of the flexible portion of the spear, especially if flared.

With respect to the above description, before explaining at least one preferred embodiment of the herein disclosed keg stacking system and method in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed keg stacking system and method. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

It is an object of the invention to provide a system for horizontally disposed stacking of beverage dispensing kegs to maximize storage in a commercial cooler.

It is an object of the invention to provide such a system, which also minimizes beverage waste, as well as maximizes the ease to which fluid conduits may be engaged with individual beverage kegs by aligning them in stacks through positioning in respective frame passages in the formed stack.

These and other features and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features of the beverage keg stacking system and method herein. It is intended that the embodiments and figures disclosed herein are to be considered illustrative rather than limiting. In the drawings:

FIG. 1 shows an overhead perspective view of a conventional beverage keg in a vertical disposition and having a portion of the sidewall cut away to reveal the spear having all or a portion formed of flexible tube and extending toward a second endwall within the interior cavity.

FIG. 2 shows a view of the device of FIG. 1, in a horizontal disposition, and depicting the spear having a portion formed from a flexible tube extending in a curve toward a sidewall of the beverage keg with a distal end of the spear formed by the flexible portion located adjacent or in contact with the sidewall.

FIG. 3 shows the stackable frame of the system herein, having a support passage formed therein which positions an engaged keg with a rear-positioned endwall at a lower elevation than a front-positioned endwall having a coupling valve therein.

FIG. 4 shows the stackable frame employed to stack a plurality of beverage kegs in a stack where two or more beverage kegs are in tilted horizontal dispositions in floor space in a cooler to increase the number of such kegs positionable in a small area of floor space.

FIG. 5 shows the beverage keg such as in FIG. 1, wherein a flexible stiffener is engaged with or made part of the hose which straighten the hose when the keg is inverted such as in FIG. 6.

FIG. 6 shows a preferred mode of the device and system herein wherein the flexible tube may form the entire spear and the flexible tube is urged to a substantially vertical position when the keg is inverted, to thereby align and position the distal end of the tube forming the spear for conventional cleaning.

Other aspects of the present invention shall be more readily understood when considered in conjunction with the accompanying drawings, and the following detailed description, neither of which should be considered limiting.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

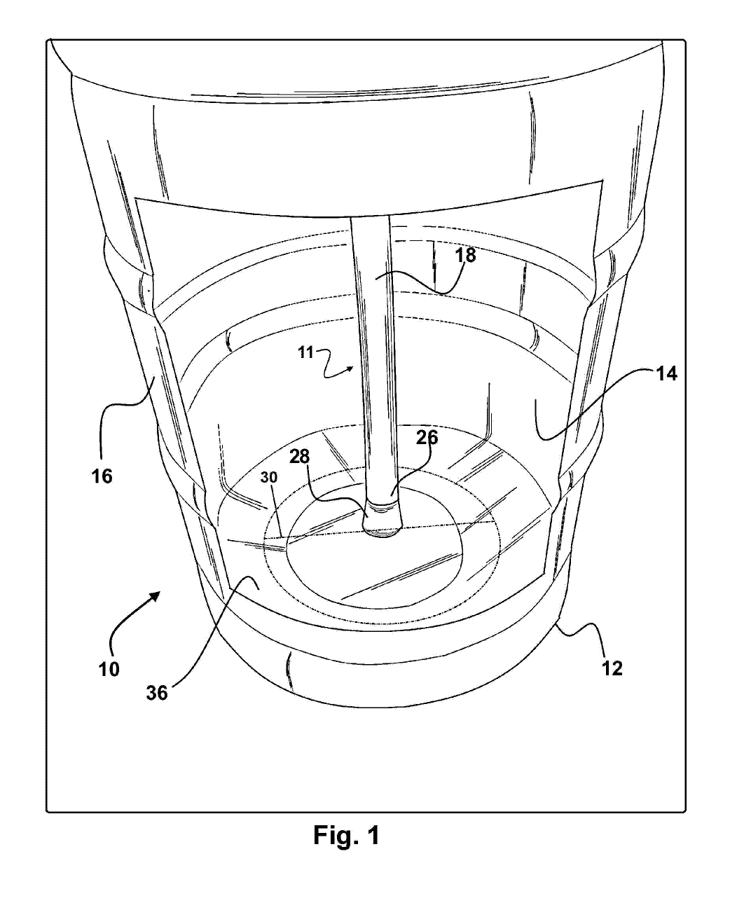

Now referring to drawings in FIGS. 1-6, wherein similar components are identified by like reference numerals, the device 10 as shown in FIG. 1, depicts an overhead perspective view of a conventional beverage keg 12 in the conventional vertical disposition used widely to dispense beverages from the internal cavity 14 of the beverage keg 12. As shown, a portion of the sidewall 16 is removed, to reveal components of the device 10 herein, which form a spear 11 adapted for positioning within the internal cavity 14 of a beverage keg 12. In a conventional beverage keg 12, the spear 11 is well known to those in the art, formed entirely by a rigid metal tube which extends from a first end in a sealed connection to the first endwall 22, to a distal end positioned immediately adjacent the second endwall 36, and due to being formed of metal entirely, remains straight.

The spear 11 herein, in all modes is formed either partially or entirely by a flexible tube 18 which at a first end of the flexible tube 18 is in a sealed connection with the bung hole 21 formed through the first endwall 22. Where spear 11 is used as a term herein, it is intended to refer to an elongated hollow member extending into a beverage keg 12 from a sealed connection with the bung hole 21 in the first endwall 22 such as an engagement with a coupling valve 20 which conventionally engages in a bung hole 21 at the first endwall 22 of such a beverage keg 12. Of course the first end of the spear 11 can engage other fittings or components which operatively engage into the bung hole 21 as would occur to those skilled in the art.

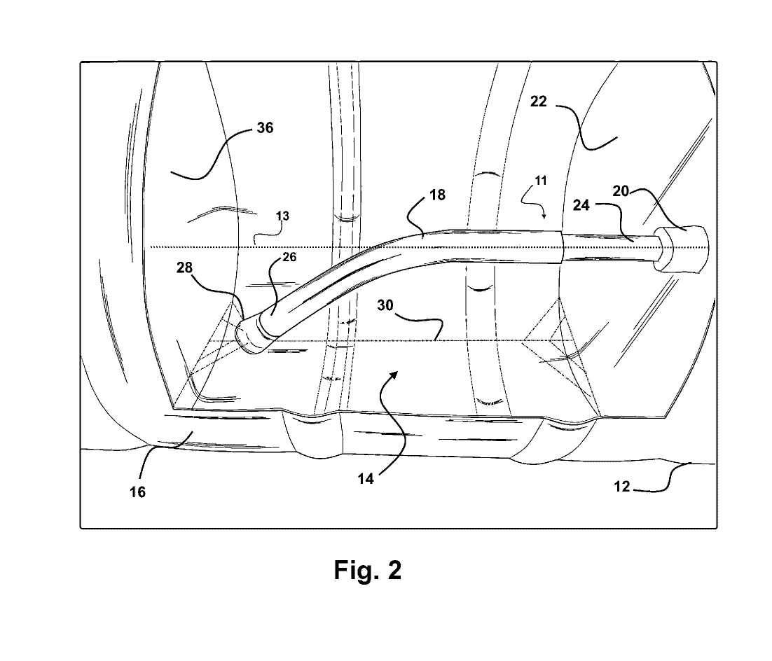

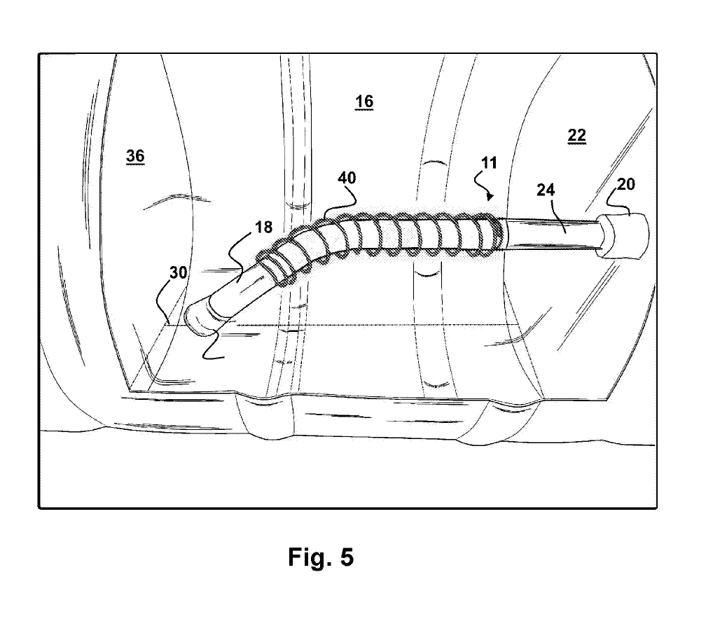

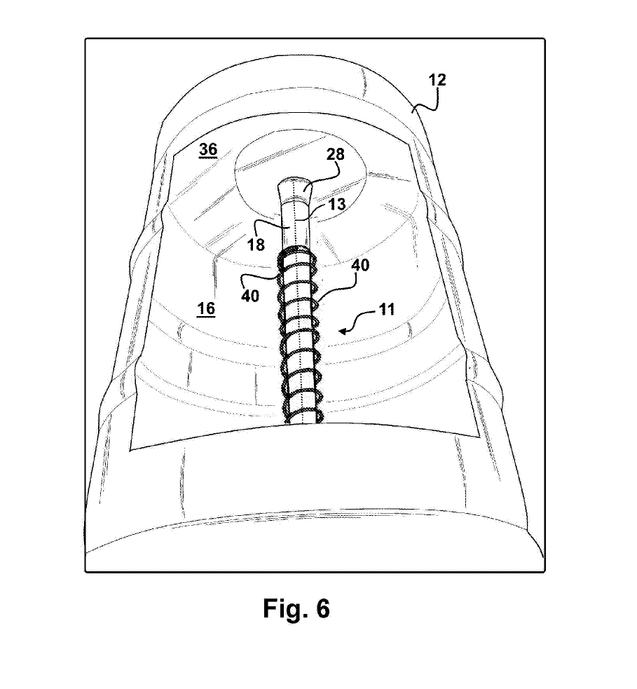

As shown the device 10 herein includes a beverage keg spear 11 a flexible tube 18 forms all or at least a portion of the elongated tube or spear 11, which is configured at a first end of the spear 11 for a sealed engagement with a hole formed in the first endwall 22 of a beverage keg 12, such as in a connection with a conventional coupling valve 20. Such coupling valves 20 are conventionally engaged in the bung hole 21 formed in a center of the first endwall 22 of the beverage keg 12 as shown in FIGS. 2 and 5. This flexible tube 18 portion can form the entire spear 11 such as shown in FIG. 6, or can engage with a rigid tube 24 extending from a sealed connection with the hole in the first endwall 22 such as to a coupling valve 20.

Currently, a flexible tube 18 formed of silicone material having an interior diameter of one inch and an exterior diameter of 1.2 inches works well. A length of the flexible tubing 18 from an end of a rigid tube 24 portion of between 10-16 inches has worked well in experimentation, and currently a length of the flexible tube 18 of 13 inches works well to form the curve and automatically position distal end 26 of the flexible tube 18 forming the distal end of the spear 11, adjacent to or in contact with the sidewall 16 and thereby within and below the level of beverage fluid 30 of the beverage in the keg 12, in an optimum position for draining the beverage keg 12 such as shown in FIGS. 2 and 5. By adjacent to is meant that an edge of the flexible tube 18 or end piece 28 if used, surrounding the intake opening 29 is spaced less than one half inch from the sidewall.

Experimentation has found that a rigid tube 24 forming the first portion of the spear or tubing extending from the coupling valve 20, has shown it may operate more efficiently than the flexible tube 18 alone. This is because the extension provided by the rigid tube 24 keeps the first end of the flexible tube 18 portion from crimping when in the horizontal orientation of FIG. 2. However, the flexible stiffener 40 shown in FIG. 6 with a spear 11 entirely of flexible tubing 18 can be made to operate almost as well.

Because the interior length of beverage kegs 12 differ, a ratio was determined after experimenting for spears 11 formed of both a rigid tube 24 and flexible tube 18. When the spear 11 is in this configuration, the length of the flexible tube 18 to the rigid tube 24, of a total length of the spear 11 when combined forms the rigid tube 24 to a length substantially 40% of the total length of the spear 11, and the flexible tube 18 to substantially 60% of the total length of the spear 11, has shown to work well in all beverage kegs 12.

By substantially is meant plus or minus 10% of the length of each of the engaged components of the flexible tube 18 and the rigid tube 24 forming a spear 11 in a sealed connection with the bung hole 21 or a connector such as a coupling valve 20. By total length is meant the length from the face of the coupling valve 20 to the distal end of the flexible tube 18 or to opening in the end piece 28 thereon which is currently substantially 19-20 inches.

However, the flexible tube 18 may also be formed in a fashion such as with flexible stiffeners 40 such as in FIGS. 5-6 or the like, to prevent over-bending and binding, and could form the entire spear from a flexible tube 18 extending between a first end engagement to the coupling valve 20 and a distal end 26 having an opening therein for fluid to flow therethrough in an axial conduit, to the operatively engaged coupling valve 20. Such a flexible stiffener 40, for example, could be a spiraled spring-like support engaged on the exterior circumference of the flexible tube 18 such as in FIGS. 5-6, at least adjacent to abutting the coupling valve 20 if so used. Currently however, the spear formed at the first end of a rigid tube 24 of a length between 7 to 9 inches, which is sealably engaged with the first end of the flexible tube 18 by a crimp or connector, has shown to enhance the ability of the flexible tube 18 by preventing kinking thereof.

It is the employment of this flexible tube 18 in the spear engaged with a coupling valve 20 of a conventional beverage keg 12, which affords the function to the device 10 to operate either in the vertical orientation of FIG. 1, or the horizontal orientation of FIGS. 2-5. Without this flexible tube 18 either forming the entire spear extending from the coupling valve or a portion thereof, operation of the beverage keg 12 in the horizontal orientation such as in FIGS. 2-5, would cause substantial beverage waste when the beverage keg 12 becomes partially drained and the fluid drops below the center axis 13 of the beverage keg 12 such as in FIG. 2. This is because a conventional spear extending as a rigid tube from the coupling valve 20 stays aligned with the center axis 13 of the beverage keg 12 in which it is positioned. Thus, the distal end of such rigid spears will not intake beverage fluid 30 once the fluid level in a horizontal disposition of the beverage keg 12, drops below the center axis 13 of the beverage keg 12.

As shown in FIGS. 1-2 and 5-6, the inclusion of a metal or weighted end piece 28, having a first end engaged within the opening at a distal end 26 of the flexible tube 18 is preferable as it provides automatic self-centering and self-leveling of the distal end of the flexible tube 18 in either the vertical orientation of FIG. 1, or the horizontal orientation of FIG. 2, or any position in between. Currently, the end piece 28 has an opening of between 0.75 to 1 inch in diameter, and is preferably flared to this width from a first end engaged with the flexible tube 18.

In order to curve the flexible lube 18 to descend the distal end 26 of the flexible tube 18 into the beverage fluid 30 in the horizontal disposition of the beverage keg 12, a weight for the end piece 28 of substantially between 250-450 grams is preferred. Currently a weight for the end piece of substantially 300 to 360 grams is especially preferred as it has shown in experimentation to curve the flexible tube 18 and sink the distal end 26 and to cause the edge surrounding the opening of the end piece 28 to contact the interior surface of the sidewall 16 without excess noise or denting it, which is desirable. In referring to weight in all cases herein, the term substantially is meant plus or minus 20% in weight.

In this fashion, the opening at a second end of the end piece 28 is always positioned in the beverage fluid 30 at its lowest point, such that the beverage fluid 30 in the beverage keg 12 is forced by compressed gas into the opening of the end piece 28, and through the axial passage of the tube formed by the flexible tube 18 and then to the rigid tube 24 if used, for fluid communication to the coupling valve 20. Thus, the weighted end piece 28, by self-positioning the end of the flexible lube 18 to the lowest point of the beverage keg 12, no matter the orientation, insures minimal waste of beverage fluid 30.

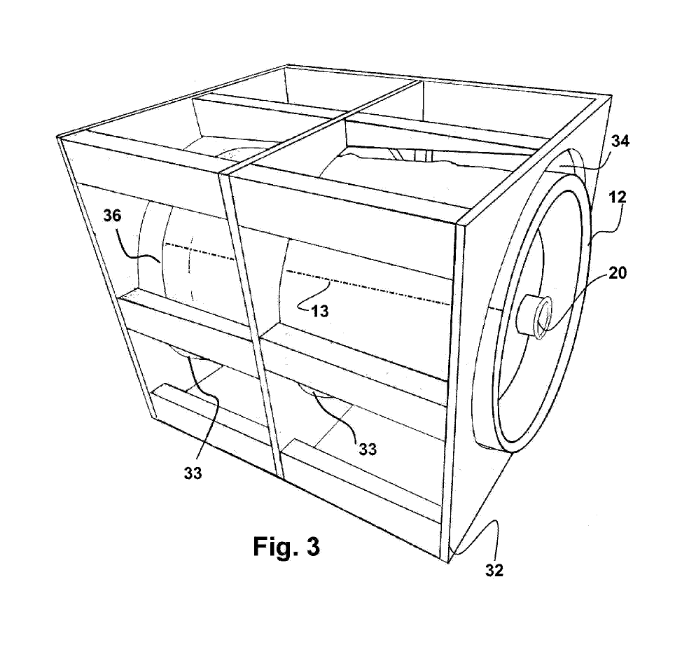

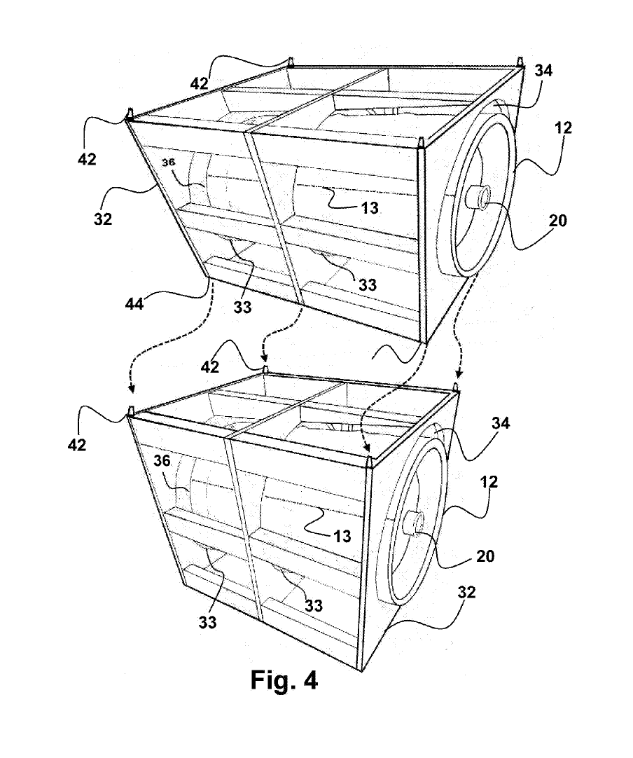

As shown in FIG. 2, the provision of a flexible tube 18 in the spear 11 extending from the coupling valve 20 either formed partially of flexible tube 18 and partially of rigid tube 24, or entirely of flexible tube 18, allows for use and positioning of the beverage keg 12 in a horizontal disposition also shown in FIGS. 3-5. However, as also noted, the end piece 28 or the distal end 26 of the flexible tube 18 herein, will always be submerged in the beverage fluid 30 since it will self-position and descend to the lowest point within the internal cavity 14 of the beverage keg 12 generally in a contact with the interior of the sidewall 16 caused by the weight of the end piece 28 curving the flexible tube 18. Thus, even where a single beverage keg 12 is employed without the preferred frame 32 shown in FIGS. 3-4, the beverage keg 12 can be used in a horizontal disposition, which is a utility lacking in conventional beverage kegs 12 having rigid spears formed of a rigid tube extending from the coupling valve 20 in the first sidewall 22.

The employment of beverage kegs 12 in this horizontal disposition of FIGS. 2-5, or in some configurations in a vertical or slanted positioning, can be enhanced using the frame 32 shown in FIG. 3, which is stackable upon other frames 32 as shown in FIG. 4, to a height only limited by the ceiling of the cooler in which they are situated. When engaged within the frame 32 the beverage keg 12 having the flexible tube 18 portion is positioned upon a support surface 33 within a passage 34 communicating into the frame 32. This support surface 33 holds the beverage keg 12 in the horizontal orientation supported by the sidewall 16 positioned on the support surface 33. This positions the center axis 13 of the beverage keg 12 such that it is in a declining angle from the coupling valve 20 relative to a flat support surface for the frame 32.

In a particularly preferred mode of the device 10, the support surface 33 formed into the frame 32 slants downward such that a lower edge of the second endwall 36 where it meets the sidewall 16, opposite the first endwall 22 in which the coupling valve 20 is engaged, is positioned at an elevation which is lower than a lower edge of the first endwall 22 where it meets the sidewall 16. This can be seen in FIG. 3, where the center axis 13 of the beverage keg 12 extending from the coupling valve 20 runs at a downward angle from the coupling valve 20 toward the second endwall 36.

This angled positioning of the beverage keg 12 on the support surface 33 of the frame 32, helps maintain the beverage keg 12 engaged within the passage 34 in the frame 32, and helps prevent it from falling out which is especially preferred where multiple frames 32 are stacked on top of each other such as in FIG. 4, thereby positioning multiple beverage kegs 12 above the one area of floor space.

Shown in FIG. 4, is a mode of the device 10 as noted, wherein a plurality of frames 32 are engaged in a stack. As shown, the frames may have cooperative fasteners on each frame to engage adjacent frames 32 stacked thereon in a registered positioning. Such cooperative fasteners can be for example pins 42 in one frame 32 which engage recesses 44 formed in registered positions in an adjacent stacked frame 32. Other such cooperative fasteners may be employed such as any removably engageable fasteners which might be found in the 2018 GRAINGER catalog and used by one skilled in the art to form a stack of frames 32 which won't slide from respective engagements, and which will align the passages 34 in each frame 32 in a stack. So stacked, all of the passages 34 in each frame 32 will have respective support surfaces 33 which engage the exterior of the sidewall 16 of an inserted beverage keg 12 and slant the axis 13 of each such keg slightly downward toward the floor or lower positioned frame 32 as the case may be.

Shown in FIG. 5, as noted earlier, is a spear device 10 as herein disclosed extending from a first end engagement to the coupling valve 20 or other fitting which is operatively engaged in the bung hole 21 formed in the first sidewall 22. As shown, a flexible stiffener 40 is engaged with the flexible tube 18. While shown as an exterior-engaged flexible stiffener 40, it could be located within the flexible tube 18 are formed as part of it in a molding or extruding process.

FIG. 6 shows a preferred mode of the device 10 similar to that of FIG. 5, however, it shows the desirable positioning of the flexible tubing 18 of the spear engaged with the coupling valve 20 in a substantially perpendicular position extending from the first endwall 22 and coupling valve 20 when the beverage keg 12 is inverted. This was found in experimentation to be desirable in some instances where perpendicular positioning of the spear from the first end to the distal end is desirable for cleaning and sanitizing the spear and the beverage keg 12. As such, inclusion of a flexible stiffener 40 around, within, or formed integral to the flexible tube 18 would be preferred where sanitizing requires this return from the curved configuration of FIG. 5 to a substantially perpendicular configuration of FIG. 6. By substantially perpendicular is meant that the center of the distal end 26 of the flexible tube 18 or the center of the opening of the end piece 28 if used, is within 20 degrees of being aligned with the axis 13 of the beverage keg 12 running from the center of the coupling 20.

It is noted and anticipated that although the keg positioning system and device 10 is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner.

While all of the fundamental characteristics and features of the keg positioning and stacking system and method of employment have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed:

1. A spear for a beverage keg, comprising:
an elongated spear having a first end connected in a sealed engagement with a bung hole in a first endwall of a beverage keg;
said spear extending from said first end to a distal end;
a portion of said spear extending from said distal end of said spear toward said first end, being formed of flexible tubing;
said spear having an elongated configuration having said flexible tubing substantially aligned with a center axis of said beverage keg while said beverage keg is in a vertical disposition supported upon a second endwall of said beverage keg, opposite said first endwall;
said spear having a curved configuration with said flexible tubing formed to a curve extending toward a sidewall of said beverage keg which extends between said first end and said second endwall of said beverage keg, with said beverage keg supported on an exterior of said sidewall in a horizontal disposition;
said curve in said flexible tubing positioning the distal end of said spear adjacent to or in a contact with an interior surface of said sidewall, whereby said distal end of said spear is positioned below a surface of a beverage fluid held in said beverage keg whether said beverage keg is in said vertical disposition or said horizontal disposition.

2. The spear for a beverage keg of claim 1, additionally comprising:
said flexible tubing forming all of said spear.

3. The spear for a beverage keg of claim 1, additionally comprising:
a first portion of said spear extending from said first end of said spear to a sealed connection with said flexible tubing;
a second portion of said spear formed by said flexible tubing extending from said sealed connection to said distal end of said spear.

4. The spear for a beverage keg of claim 1, additionally comprising:
an end piece engaged with a distal end of said spear; and
said end piece having a weight imparting force to said distal end of said spear, said force urging said flexible tubing to form said curve.

5. The spear for a beverage keg of claim 2, additionally comprising:
an end piece engaged with a distal end of said spear; and
said end piece having a weight imparting force to said distal end of said spear, said force urging said flexible tubing to form said curve.

6. The spear for a beverage keg of claim 3, additionally comprising:
an end piece engaged with a distal end of said spear; and
said endpiece having a weight imparting force to said distal end of said spear, said force urging said flexible tubing to form said curve.

7. The spear for a beverage keg of claim 5, wherein said weight is substantially between 250-450 grams.

8. The spear for a beverage keg of claim 6, wherein said weight is substantially between 250-450 grams.

9. The spear for a beverage keg of claim 1 additionally comprising:
a flexible stiffener engaged with said flexible tubing; and
said flexible stiffener holding said flexible tubing substantially aligned with said center axis of said beverage keg with said beverage keg inverted from said vertical disposition supported on said second endwall.

10. The spear for a beverage keg of claim 2 additionally comprising:
a flexible stiffener engaged with said flexible tubing; and
said flexible stiffener holding said flexible tubing substantially aligned with said center axis of said beverage keg with said beverage keg inverted from said vertical disposition supported on said second endwall.

11. The spear for a beverage keg of claim 3 additionally comprising:
a flexible stiffener engaged with said flexible tubing; and
said flexible stiffener holding said flexible tubing substantially aligned with said center axis of said beverage keg with said beverage keg inverted from said vertical disposition supported on said second endwall.

12. The spear for a beverage keg of claim 1, additionally comprising:
a frame, said frame having a passage therethrough communicating between a first end of said frame to a second end of said frame, said passage having a support surface;
said support surface slanting between said first end of said frame and said second end of said frame whereby said support surface at said first end of said frame is at a higher elevation than said support surface at said second end of said frame; and
said beverage keg removably positionable within said passage in said horizontal disposition with said sidewall resting upon said support surface, thereby positioning said first sidewall at an elevation higher than said second sidewall of said beverage keg.

13. The spear for a beverage keg of claim 2, additionally comprising:
a frame, said frame having a passage therethrough communicating between a first end of said frame to a second end of said frame, said passage having a support surface;
said support surface slanting between said first end of said frame and said second end of said frame whereby said support surface at said first end of said frame is at a higher elevation than said support surface at said second end of said frame; and
said beverage keg removably positionable within said passage in said horizontal disposition with said sidewall resting upon said support surface, thereby positioning said first sidewall at an elevation higher than said second sidewall of said beverage keg.

14. The spear for a beverage keg of claim 5, additionally comprising:
a frame, said frame having a passage therethrough communicating between a first end of said frame to a second end of said frame, said passage having a support surface;
said support surface slanting between said first end of said frame and said second end of said frame whereby said support surface at said first end of said frame is at a higher elevation than said support surface at said second end of said frame; and
said beverage keg removably positionable within said passage in said horizontal disposition with said sidewall resting upon said support surface, thereby positioning said first sidewall at an elevation higher than said second sidewall of said beverage keg.

15. The spear for a beverage keg of claim 6, additionally comprising:
a frame, said frame having a passage therethrough communicating between a first end of said frame to a second end of said frame, said passage having a support surface;
said support surface slanting between said first end of said frame and said second end of said frame whereby said support surface at said first end of said frame is at a higher elevation than said support surface at said second end of said frame; and
said beverage keg removably positionable within said passage in said horizontal disposition with said sidewall resting upon said support surface, thereby positioning said first sidewall at an elevation higher than said second sidewall of said beverage keg.

16. The spear for a beverage keg of claim 12, additionally comprising:
a plurality of said frames formed to a stacked configuration;
each of said frames in said plurality having a said beverage keg respectfully positionable therein with said first sidewall thereof at or adjacent said first end of said frame, whereby a plurality of said beverage kegs is each positionable to said horizontal disposition elevated above a floor surface sized to support the lowest of said plurality of frames in said stacked configuration.

17. The spear for a beverage keg of claim 13, additionally comprising:
a plurality of said frames formed to a stacked configuration;
each of said frames in said plurality having a said beverage keg respectfully positionable therein with said first sidewall thereof at or adjacent said first end of said frame, whereby a plurality of said beverage kegs is each positionable to said horizontal disposition elevated above a floor surface sized to support the lowest of said plurality of frames in said stacked configuration.

18. The spear for a beverage keg of claim 14, additionally comprising:
a plurality of said frames formed to a stacked configuration;
each of said frames in said plurality having a said beverage keg respectfully positionable therein with said first sidewall thereof at or adjacent said first end of said frame, whereby a plurality of said beverage kegs is each positionable to said horizontal disposition elevated above a floor surface sized to support the lowest of said plurality of frames in said stacked configuration.

19. The spear for a beverage keg of claim 15, additionally comprising:
a plurality of said frames formed to a stacked configuration;
each of said frames in said plurality having a said beverage keg respectfully positionable therein with said first sidewall thereof at or adjacent said first end of said frame, whereby a plurality of said beverage kegs is each positionable to said horizontal disposition elevated above a floor surface sized to support the lowest of said plurality of frames in said stacked configuration.
